(19) United States
(12) Patent Application Publication
(10) Pub. No.: US 2026/0301485 A1
(43) Pub. Date: Oct. 1, 2026

(54) DISPLAY CONTROL SYSTEM FOR WORK MACHINE

(71) Applicant: KOMATSU LTD., Tokyo (JP)

(72) Inventors: Minami Sugimura, Tokyo (JP); Norihiro Kobayashi, Tokyo (JP)

(73) Assignee: KOMATSU LTD., Tokyo (JP)

(21) Appl. No.: 19/480,427

(22) PCT Filed: Jun. 28, 2024
(86) PCT No.: PCT/JP2024/023639

§ 371 Date: Oct. 31, 2025

(30) Foreign Application Priority Data
Jun. 29, 2023 (JP) 2023-106847

(51) Int. Cl. G07C 5/08; B60L 50/60; B60L 58/12; E02F 3/32; E02F 9/26

(52) U.S. Cl. CPC G07C 5/0825; B60L 50/60; B60L 58/12; E02F 9/26; B60L 2200/40; E02F 3/32

(57) ABSTRACT

An output unit outputs a value related to power consumption in a target time period and a work content of a work machine in the target time period.

### TECHNICAL FIELD

The present disclosure relates to a display control system for a work machine.

The present application claims priority based on Japanese Patent Application No. 2023-106847, filed Jun. 29, 2023, the content of which is incorporated herein by reference.

### BACKGROUND ART

In construction work in urban areas and the like, an electrically-driven work machine with zero emission and low noise may be used. The electrically-driven work machine does not include an engine or a fuel tank, but includes an electric motor that drives a hydraulic pump or the like, and an electric storage device such as a battery that supplies electric power to the electric motor. Such an electrically-driven work machine requires a time for charging as compared with an engine-driven work machine. Therefore, it is important for an operator to be aware of the remaining operating time of the electrically-driven work machine.

Patent Document 1 discloses a display device that is mounted on a work machine including an electric motor as a power source and displays a remaining battery level or a remaining operating time of a work vehicle.

### CITATION LIST

### Patent Literature

Patent Document 1: JP 2007-288894 A

### SUMMARY OF INVENTION

### Technical Problem

The power consumption of a work machine varies depending on the behavior of the work machine. Therefore, it is required to enable a user to recognize the relationship between a work content and power consumption.

An object of the present disclosure is to provide a display control system for a work machine capable of enabling a user to recognize the relationship between a work content and power consumption.

### Solution to Problem

According to an aspect of the present disclosure, a display control system for a work machine is a display control system for a work machine driven by a battery and includes an output unit that outputs a value related to power consumption in a target time period and a work content of the work machine in the target time period.

### Advantageous Effects of Invention

According to the above-described aspect, the display control system can enable a user to recognize the relationship between a work content and power consumption.

### BRIEF DESCRIPTION OF DRAWINGS

FIG. 1 is a schematic diagram illustrating a configuration of a display control system according to a first embodiment.

FIG. 2 is a diagram illustrating a configuration of a work machine according to the first embodiment.

FIG. 3 is a diagram illustrating an internal configuration of a cab according to the first embodiment.

FIG. 4 is a schematic block diagram illustrating a configuration of a work analysis device according to the first embodiment.

FIG. 5 is a flowchart illustrating a method of presenting a screen by the work analysis device according to the first embodiment.

FIG. 6 is a diagram illustrating an example of a display screen according to the first embodiment.

### DESCRIPTION OF EMBODIMENTS

### First Embodiment

### Overall Configuration

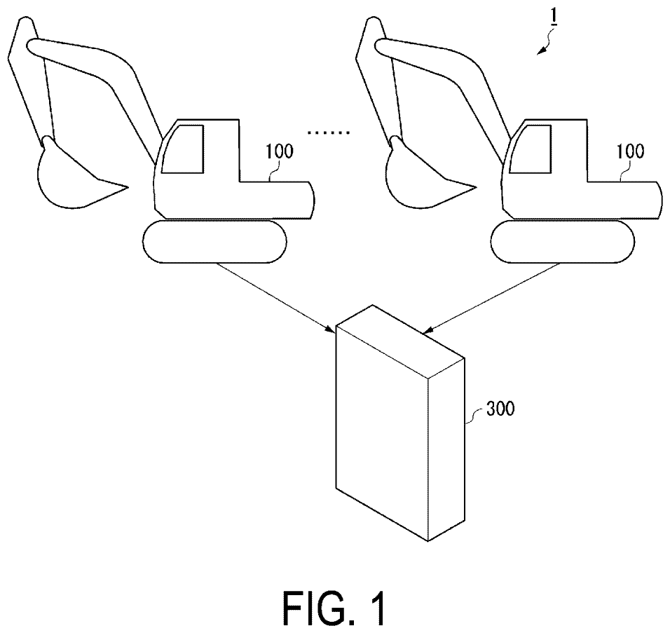

FIG. 1 is a schematic diagram illustrating a configuration of a display control system 1 according to the first embodiment. The display control system 1 includes a work machine 100 and a work analysis device 300. The work analysis device 300 analyzes work of the work machine 100 and generates a screen for displaying a work history and a remaining operating time of the work machine. A user can recognize the remaining operating time of the work machine 100 by visually checking the screen output by the work analysis device 300.

The work machine 100 is a target of work analysis by the work analysis device 300. Examples of the work machine 100 include other work machines such as a hydraulic excavator and a wheel loader. In the first embodiment, an electrically-driven hydraulic excavator will be described as an example of the work machine 100. The work machine 100 is provided with a plurality of sensors, and information on a measurement value of each sensor is transmitted to the work analysis device 300.

### Work Machine 100

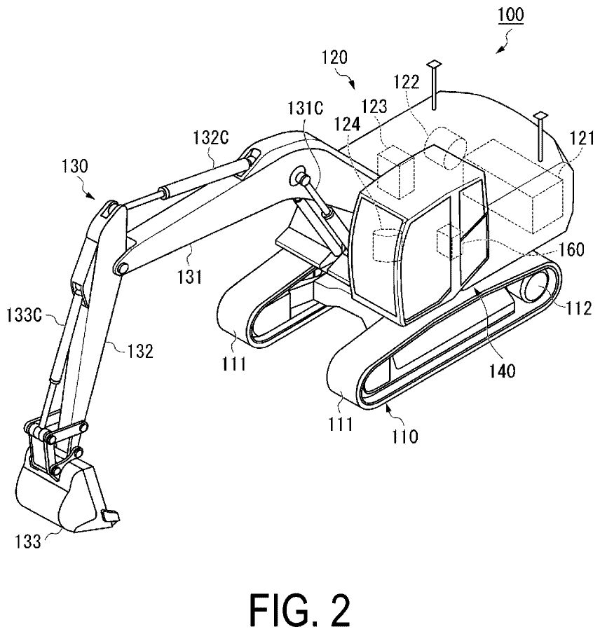

FIG. 2 is a diagram illustrating a configuration of the work machine 100 according to the first embodiment. The work machine 100 operates at a construction site, excavates a construction target such as earth and sand, and loads the construction target onto a loading platform such as a vessel of a loading target T such as a dump truck. Examples of the work machine 100 include a face shovel, a backhoe shovel, and a rope shovel. Further, the work machine 100 may be electrically driven or may be hydraulically driven. The work machine 100 according to the first embodiment is a backhoe shovel. The work machine 100 includes a traveling body 110, a revolving body 120, a work implement 130, and a cab 140. Examples of the loading target T include a dump truck and a hopper.

The traveling body 110 supports the work machine 100 such that the work machine 100 can travel. The traveling body 110 includes two endless tracks 111 provided on left and right sides and two travel motors 112 for driving the endless tracks 111. The traveling body 110 is an example of a support part.

The revolving body 120 is supported by the traveling body 110 so as to be revolvable about a revolution center.

The work implement 130 is driven by hydraulic pressure. The work implement 130 is supported at a front portion of the revolving body 120 so as to be drivable in an up-down direction.

The cab 140 is a space where an operator rides and operates the work machine 100. The cab 140 is provided in a left front portion of the revolving body 120.

Here, a portion of the revolving body 120 where the work implement 130 is attached is referred to as a front portion. Further, in the revolving body 120, with reference to the front portion, a portion on a side opposite to the front portion is referred to as a rear portion, a portion on the left side is referred to as a left portion, and a portion on the right side is referred to as a right portion.

### Configuration of Revolving Body 120

The revolving body 120 includes a battery 121, a hydraulic pump 122, a control valve 123, and a revolution motor 124.

The battery 121 is a power source that drives the hydraulic pump 122.

The hydraulic pump 122 is an electric pump driven by electric power supplied from the battery 121. The hydraulic pump 122 supplies hydraulic oil to actuators (a boom cylinder 131C, an arm cylinder 132C, a bucket cylinder 133C, the travel motors 112, and the revolution motor 124) via the control valve 123.

The control valve 123 controls a flow rate of the hydraulic oil supplied from the hydraulic pump 122.

The revolution motor 124 is driven by the hydraulic oil supplied from the hydraulic pump 122 via the control valve 123 and revolves the revolving body 120.

### Configuration of Work Implement 130

The work implement 130 includes a boom 131, an arm 132, a bucket 133 as a work tool, the boom cylinder 131C, the arm cylinder 132C, and the bucket cylinder 133C. Other examples of the work tool include distal end attachments such as a clamshell bucket, a tilt bucket, a tilt rotator bucket, a grapple, and a lifting magnet.

A base end portion of the boom 131 is rotatably attached to the revolving body 120 via a boom pin. In the work machine 100 illustrated in FIG. 1, the boom 131 is provided at a front center portion of the revolving body 120, but the position is not limited thereto, and the boom 131 may be attached offset in a left-right direction. In that case, the revolution center of the revolving body 120 is not located on an operation plane of the work implement 130.

The arm 132 couples the boom 131 and the bucket 133. A base end portion of the arm 132 is rotatably attached to a distal end portion of the boom 131 via an arm pin.

The bucket 133 is rotatably attached to a distal end portion of the arm 132 via a pin. The boom 131 and the arm 132 are members that support the bucket 133. The bucket 133 serves as a container for accommodating excavated earth and sand.

The boom cylinder 131C is a hydraulic cylinder for actuating the boom 131. A base end portion of the boom cylinder 131C is attached to the revolving body 120. A distal end portion of the boom cylinder 131C is attached to the boom 131.

The arm cylinder 132C is a hydraulic cylinder for driving the arm 132. A base end portion of the arm cylinder 132C is attached to the boom 131. A distal end portion of the arm cylinder 132C is attached to the arm 132.

The bucket cylinder 133C is a hydraulic cylinder for driving the bucket 133. A base end portion of the bucket cylinder 133C is attached to the arm 132. A distal end portion of the bucket cylinder 133C is attached to a link mechanism that turns the bucket 133.

### Configuration of Cab 140

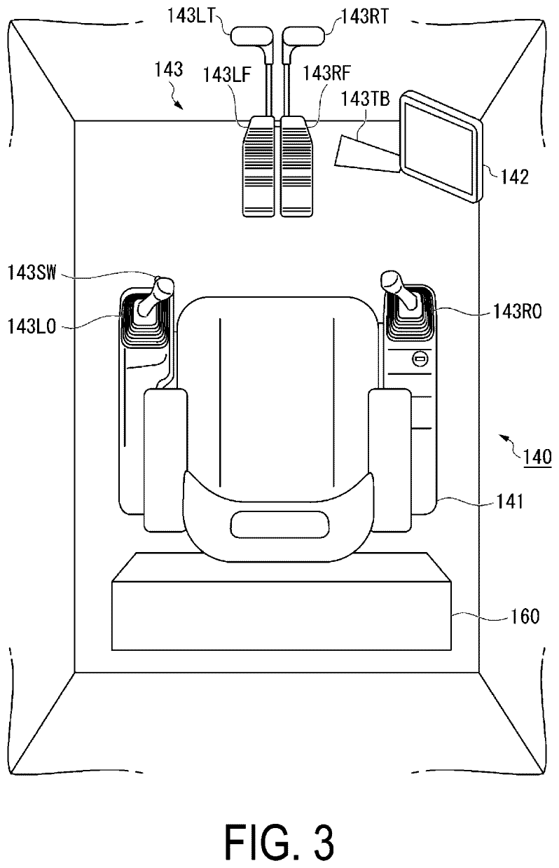

FIG. 3 is a diagram illustrating an internal configuration of the cab 140 according to the first embodiment.

An operator seat 141, an operation terminal 142, an operation device 143, and a control device 160 are provided in the cab 140. The operation terminal 142 is provided in the vicinity of the operator seat 141. The operation terminal 142 is a display device including a touch panel, for example. Further, the operation terminal 142 may include a display device such as an LCD.

The operation device 143 is a device for driving the traveling body 110, the revolving body 120, and the work implement 130 by manual operation by the operator. The operation device 143 includes a left operation lever 143LO, a right operation lever 143RO, a left foot pedal 143LF, a right foot pedal 143RF, a left travel lever 143LT, a right travel lever 143RT, and a revolution brake pedal 143TB.

The left operation lever 143LO is provided on the left side of the operator seat 141. The right operation lever 143RO is provided on the right side of the operator seat 141.

The left operation lever 143LO is an operation mechanism for performing a revolution operation of the revolving body 120 and an excavation/dumping operation of the arm 132. Specifically, when the operator of the work machine 100 tilts the left operation lever 143LO in a forward direction, the arm 132 performs the dumping operation. When the operator of the work machine 100 tilts the left operation lever 143LO in a rearward direction, the arm 132 performs the excavation operation. When the operator of the work machine 100 tilts the left operation lever 143LO in a rightward direction, the revolving body 120 revolves to the right. When the operator of the work machine 100 tilts the left operation lever 143LO in a leftward direction, the revolving body 120 revolves to the left. Note that, in another embodiment, the revolving body 120 may revolve to the right or the left when the left operation lever 143LO is tilted in a front-rear direction, and the arm 132 may perform the excavation operation or the dumping operation when the left operation lever 143LO is tilted in the left-right direction.

The right operation lever 143RO is an operation mechanism for performing the excavation/dumping operation of the bucket 133 and a raising/lowering operation of the boom 131. Specifically, when the operator of the work machine 100 tilts the right operation lever 143RO in the forward direction, the lowering operation of the boom 131 is performed. When the operator of the work machine 100 tilts the right operation lever 143RO in the rearward direction, the raising operation of the boom 131 is performed. When the operator of the work machine 100 tilts the right operation lever 143RO in the rightward direction, the dumping operation of the bucket 133 is performed. When the operator of the work machine 100 tilts the right operation lever 143RO in the leftward direction, the excavation operation of the bucket 133 is performed. Note that, in another embodiment, the bucket 133 may perform the dumping operation or the excavation operation when the right operation lever 143RO is tilted in the front-rear direction, and the boom 131 may perform the raising operation or the lowering operation when the right operation lever 143RO is tilted in the left-right direction.

The left foot pedal 143LF is disposed on the left side of a floor surface in front of the operator seat 141. The right foot pedal 143RF is disposed on the right side of the floor surface in front of the operator seat 141. The left travel lever 143LT is pivotally supported by the left foot pedal 143LF and is configured such that the tilting of the left travel lever 143LT and a depression of the left foot pedal 143LF are interlocked with each other. The right travel lever 143RT is pivotally supported by the right foot pedal 143RF and is configured such that the tilting of the right travel lever 143RT and a depression of the right foot pedal 143RF are interlocked with each other.

The left foot pedal 143LF and the left travel lever 143LT correspond to the rotational driving of a left-side crawler of the traveling body 110. Specifically, when the operator of the work machine 100 tilts the left foot pedal 143LF or the left travel lever 143LT in the forward direction, the left-side crawler rotates in the forward traveling direction. When the operator of the work machine 100 tilts the left foot pedal 143LF or the left travel lever 143LT in the rearward direction, the left-side crawler rotates in the rearward traveling direction.

The right foot pedal 143RF and the right travel lever 143RT correspond to the rotational driving of a right-side crawler of the traveling body 110. Specifically, when the operator of the work machine 100 tilts the right foot pedal 143RF or the right travel lever 143RT in the forward direction, the right-side crawler rotates in the forward traveling direction. When the operator of the work machine 100 tilts the right foot pedal 143RF or the right travel lever 143RT in the rearward direction, the right-side crawler rotates in the rearward traveling direction.

The control device 160 collects measurement data collected from the plurality of sensors included in the work machine 100 and operation amounts of the operation device 143, and stores the measurement data and the operation amounts in association with time stamps. The control device 160 transmits a time series of measurement data and operation amounts to the work analysis device 300. The control device 160 is a computer including a processor, a main memory, a storage, and an interface (all of these components are not illustrated). The storage of the control device 160 stores a data aggregation program. The processor of the control device 160 reads the data aggregation program from the storage, loads the data aggregation program into the main memory, and executes a process of collecting measurement data and operation amounts in accordance with the data aggregation program and transmitting the same. The control device 160 may be provided inside or outside the work machine 100.

The work machine 100 includes the plurality of sensors. Each of the sensors outputs a measurement value to the control device 160. The work machine 100 includes at least a power meter that measures the power consumption of the battery 121 and a battery level meter that measures the remaining level of the battery 121. The work machine 100 may include, as the sensors, a cylinder stroke sensor for determining the orientation of the work implement 130, a pressure sensor for determining the weight of the work implement 130, an IMU for measuring the revolution angle of the revolving body 120, and the like.

### Configuration of Work Analysis Device

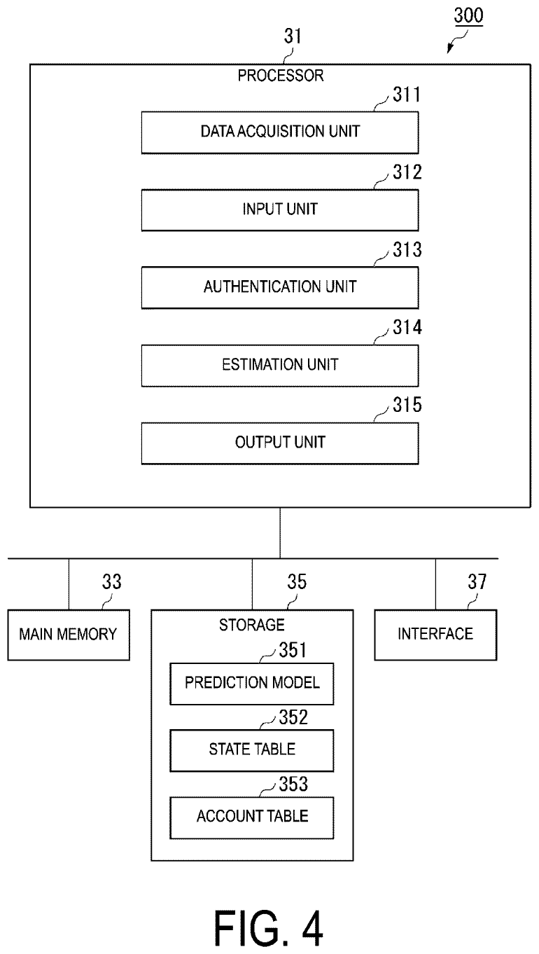

FIG. 4 is a schematic block diagram illustrating a configuration of the work analysis device according to the first embodiment.

The work analysis device 300 is a computer including a processor 31, a main memory 33, a storage 35, and an interface 37. The storage 35 stores a work analysis program. The processor 31 reads the work analysis program from the storage 35, loads the work analysis program into the main memory 33, and executes processing according to the work analysis program. Note that the work analysis device 300 according to the first embodiment is provided outside the work machine 100, but in another embodiment, a part or all of the functions of the work analysis device 300 may be provided inside the work machine 100.

Examples of the storage 35 include a semiconductor memory, a disk medium, and a tape medium. The storage 35 may be an internal medium directly connected to a common communication line of the work analysis device 300, or may be an external medium connected to the work analysis device 300 via the interface 37. The storage 35 is a non-transitory tangible storage medium.

The processor 31 includes a data acquisition unit 311, an input unit 312, an authentication unit 313, an estimation unit 314, and an output unit 315 by executing the work analysis program. The work analysis program stored in the storage 35 includes a prediction model 351. The prediction model is a learning model that has been trained by being input with a time series of measurement data and operation amounts so as to output a time series of work sections. The prediction model 351 is trained using, as a learning data set, a combination of the time series of measurement data and operation amounts and a time series of labels of work sections of the work machine 100 when the measurement data is collected. The prediction model may be, for example, a neural network model. In addition, in the storage 35, storage regions of a state table 352 that stores state data for each work machine 100 and an account table 353 that stores account data of users are secured.

The state table 352 stores a work machine ID, a time, a type of state data, and a value of the state data in association with each other. The account table 353 stores a user ID, a password, one or more work machine IDs for which viewing of state data is permitted in association with each other.

The work analysis device 300 according to the first embodiment functions as a web server. That is, the work analysis device 300 receives a request message (HTTP request) from a display device operated by a user, executes predetermined processing, and outputs a response message for screen display.

The data acquisition unit 311 acquires a time series of state data indicating the state of the work machine 100 from the control device 160 of the work machine 100. That is, the data acquisition unit 311 acquires a plurality of combinations of a time stamp and state data. The state data may include a measurement value of each sensor of the work machine 100 and a value obtained by the control device 160 based on the measurement value. The data acquisition unit 311 stores the acquired time series of state data in the state table 352 of the storage 35 in association with the ID of the work machine 100.

The input unit 312 receives a request message from a user. The request message may include a value of a request parameter.

The authentication unit 313 performs a user authentication process. For example, the authentication unit 313 performs the authentication process by collating a user ID and a password indicated by a request parameter added to a request message with the data of the account table 353.

The estimation unit 314 obtains a time series of work sections based on a new time series of state data acquired by the data acquisition unit 311 and the prediction model 351 stored in the storage 35. Specifically, the estimation unit 314 acquires a time series of work sections by inputting time series data of state data to the prediction model.

The estimation unit 314 determines a unit work section and an element work section as a work section. The unit work is work for performing one work purpose. The element work is a work indicating a series of operations or works which are elements constituting a unit work and are classified by purposes.

Examples of element work sections include “excavation”, “loaded revolving”, “unloading”, “unloaded revolving”, “waiting for unloading”, “loading platform pressing”, “compacting”, “push leveling”, “sweeping”, and the like. “Excavation” is work of excavating and removing earth and sand, or rocks by the bucket 133.

“Loaded revolving” is work of revolving the revolving body 120 while holding the removed earth and sand, or rocks in the bucket 133.

“Unloading” is work of discharging the removed earth and sand, or rocks from the bucket 133 to a transport vehicle or a predetermined place. “Unloaded revolving” is work of revolving the revolving body 120 without earth and sand, or rocks in the bucket 133.

“Waiting for unloading” is work of waiting for a transport vehicle for loading while holding the removed earth and sand, or rocks in the bucket 133.

“Loading platform pressing” is work of pressing the earth and sand loaded on a loading platform of a transport vehicle from above with the bucket 133 to flatten the earth and sand.

“Compacting” is work of pushing earth and sand into disturbed ground with the bucket 133 to shape and strengthen the ground.

“Push leveling” is work of sweeping and leveling earth and sand with the bottom surface of the bucket 133.

“Sweeping” is work of sweeping and leveling earth and sand with a side surface of the bucket 133.

Examples of unit work sections include “dump loading”, “load collection”, “traveling”, “stopping”, and “charging”.

“Dump loading” is work of excavating and removing earth and sand, or rocks, and loading the removed earth and sand, or rocks onto a loading platform of a transport vehicle such as a dump truck. Dump loading is a unit work including excavation, loaded revolving, unloading, unloaded revolving, waiting for unloading, and loading platform pressing.

“Load collection” is work of collecting earth and sand produced by excavation or the like before loading the earth and sand on a transport vehicle. Load collection is a unit work including excavation, loaded revolving, unloading, and unloaded revolving, and may include push leveling.

“Traveling” is work of moving the work machine 100. Traveling as a unit work is a unit work including traveling as an element work.

“Stopping” is a state of stopping for a predetermined time or more without earth and sand, or rocks in the bucket 133. Stopping as a unit work is a unit work including stopping as an element work.

“charging” Is an Operation of Charging the Battery 121.

The output unit 315 outputs a response message for displaying a display screen of the work section estimated by the estimation unit 314.

### Operation of Display Control System 1

The control device 160 of the work machine 100 transmits measurement data of the sensors and time series data of operation amounts of the operation device 143 to the work analysis device 300 at regular time intervals. The data acquisition unit 311 of the work analysis device 300 records the received time series data in the storage 35 in association with the ID of the work machine 100.

A user such as an operator of the work machine 100, an owner of the work machine, or a person in charge of a construction site accesses the work analysis device 300 using a display device such as a PC or a smartphone in order to grasp the state of the work machine 100. For example, the user accesses the work analysis device 300 by a web browser of the display device. The display device may be the operation terminal 142 of the work machine 100.

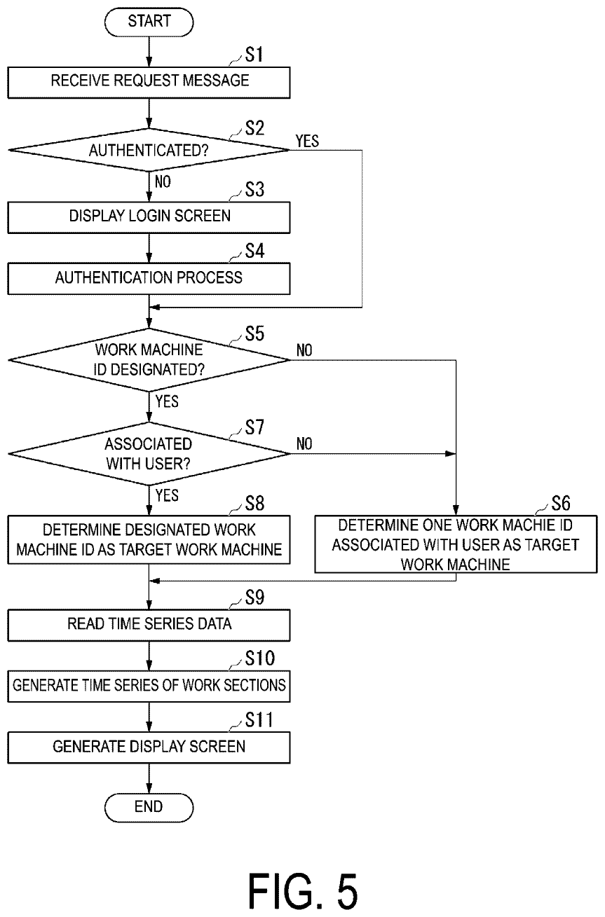

FIG. 5 is a flowchart illustrating a method of presenting a screen by the work analysis device 300 according to the first embodiment. The flowchart illustrated in FIG. 5 is merely an example, and the order and contents of some processes may be different in another embodiment. When the input unit 312 of the work analysis device 300 receives a request message from the display device (step S1), the authentication unit 313 determines whether the user has been authenticated (step S2). When the user has not been authenticated (step S2: NO), the output unit 315 generates a response message for displaying a login screen for authentication of the user, and outputs the response message to the display device (step S3). The login screen includes input forms for a user ID and a password. The user inputs the user ID and the password on the login screen. The display device transmits a request message having values of the user ID and the password as request parameters.

When the input unit 312 receives the request message, the authentication unit 313 performs an authentication process by collating the user ID and the password related to the response parameter with the data of the account table 353 (step S4).

When the user has been authenticated (step S2: YES), or when the authentication process has been completed in step S4, the work analysis device 300 starts generating a display screen for the remaining operating time of the work machine 100.

The input unit 312 determines whether a value of a work machine ID for identifying the work machine 100 to be displayed is designated as a request parameter in the request message (step S5).

When the value of the work machine ID has not been designated as the request parameter (step S5: NO), the input unit 312 determines the work machine 100 related to the work machine ID at the top among one or more work machines 100 associated with the authenticated user in the account table 353 as a target work machine (step S6).

When the value of the work machine ID has been designated as the request parameter (step S5: YES), the input unit 312 determines whether the value of the work machine ID is associated with the authenticated user in the account table 353 (step S7). When the value of the work machine ID is associated with the authenticated user in the account table 353 (step S7: YES), the input unit 312 determines the work machine 100 related to the work machine ID as the target work machine (step S8).

When the value of the work machine ID is not associated with the authenticated user in the account table 353 (step S7: NO), the input unit 312 determines the work machine 100 related to the work machine ID at the top among one or more work machines 100 associated with the authenticated user in the account table 353 as the target work machine (step S6).

The estimation unit 314 reads, from the state table 352 of the storage 35, the determined work machine ID, and the measurement data and the operation amount of the operation device 143 associated with a time within the target period having the current time as the end point, as time series data (step S9). The target period is, for example, 24 hours. The end point and the start point in the target period may be arbitrarily designated by the user. The estimation unit 314 inputs the read time series data to the prediction model 351, thereby generating a time series of work sections of the work machine 100 in the target period (step S10).

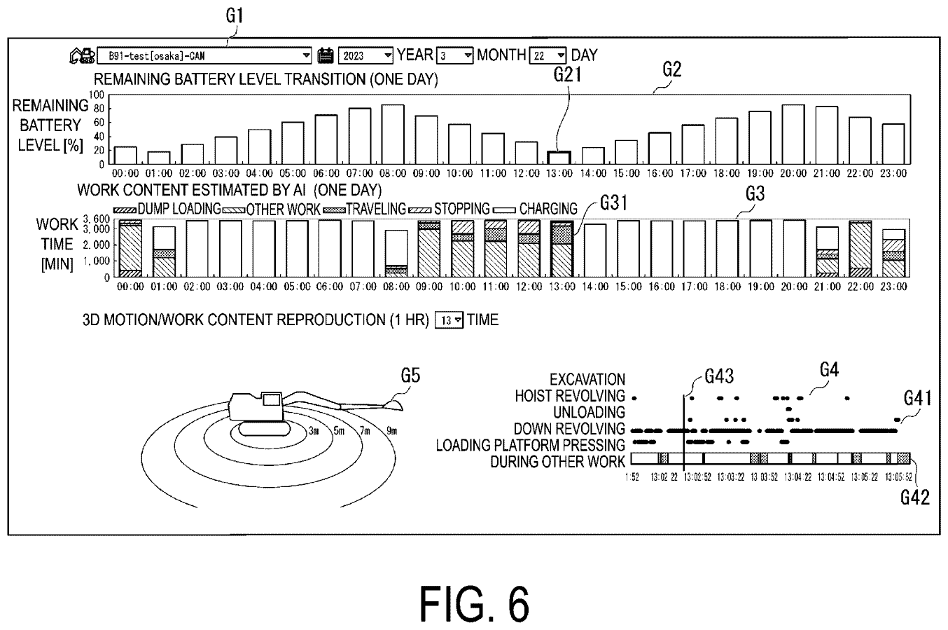

The output unit 315 generates a display screen that displays the transition of the remaining level of the battery 121, the transition of the work sections performed by the work machine 100, and the behavior of the work machine 100 in a specific time period, and transmits a response message for displaying the display screen (step S11). FIG. 6 is a diagram illustrating an example of the display screen according to the first embodiment.

The display screen includes a work machine selection form G1, a remaining battery level graph G2, a unit work graph G3, a work section map G4, and a three-dimensional model G5.

The work machine selection form G1 receives selection of the work machine 100 associated with the authenticated user. In the display screen, the initial value of the work machine selection form G1 indicates the target work machine determined in step S6 or step S8. The remaining battery level graph G2 is a graph in which the vertical axis represents remaining battery level and the horizontal axis represents time. The remaining battery level graph G2 displays, for example, the remaining battery level at the terminal end of each hourly time period as a bar graph.

The unit work graph G3 is a graph in which the vertical axis represents accumulated time and the horizontal axis represents time. The unit work graph G3 displays, for example, the execution time of each unit work section for each hourly time period as a stacked bar graph.

In the remaining battery level graph G2 and the unit work graph G3, cursors G21 and G31 indicating bars related to a selected time period among a plurality of bars are displayed.

The work section map G4 is a map that indicates a temporal change in work sections in a selected time period. The work section map G4 includes an element work map G41 and a unit work graph G42. The element work map G41 is a map that indicates plots representing element work sections on a plane in which the vertical axis represents element work section and the horizontal axis represents time. The unit work map G42 is a graph in which unit work sections are arranged for each time with the horizontal axis aligned with the element work map G41. The unit work sections in the unit work map G42 are indicated by different colors. A cursor G43 indicating time is displayed on the work section map G4.

The three-dimensional model G5 reproduces the orientation of the work machine 100 at the time indicated by the cursor G43 of the work section map G4. Since the time indicated by the cursor G43 advances with the lapse of time, the three-dimensional model G5 is displayed as an animation of the change in the orientation of the work machine 100 in the time period indicated by the cursors G21 and 31.

The data of the display screen included in the response message of the display screen may include a script program described by Javascript (registered trademark) or the like. For example, the animation of the three-dimensional model G5 may be implemented by the display device executing the script program. Specifically, the browser that displays the display screen executes the following processing in accordance with the script program.

The display device receives a selection of a time period displayed on the remaining battery level graph G2 or the unit work graph G3 from the user. Specifically, the display device receives a selection of a time period when any bar constituting the remaining battery level graph G2 or the unit work graph G3 is clicked. When a time period is selected, the display device displays the cursors G21 and G31 at the bars related to the selected time period among the plurality of bars constituting the remaining battery level graph G2 and the unit work graph G3. The display device transmits, to the work analysis device 300, a request message for requesting time series data of the unit work sections and the element work sections related to the selected time period and time series data of the angles of the revolving body 120, the boom 131, the arm 132, and the bucket 133 related to the time period. The request message includes a request parameter indicating the selected time period. The output unit 315 of the work analysis device 300 transmits, as a response to the received request message, a response message including the time series data of the unit work sections and the element work sections related to the selected time period and the time series data of the angles of the revolving body 120, the boom 131, the arm 132, and the bucket 133 related to the time period. Note that the display device may execute the processing related to the request message as asynchronous processing.

The display device draws the work section map G4 based on the received time series data of the unit work sections and the element work sections. The display device places the cursor G43 at a position corresponding to the starting end of the time period in the work section map G4. The display device moves the cursor G43 toward the terminal end of the time period in the work section map G4 along with the lapse of time. The display device draws the three-dimensional model G5 indicating the orientation of the work machine 100 at the time indicated by the cursor G43 based on the received time series data of the angles of the revolving body 120, the boom 131, the arm 132, and the bucket 133. The display device changes the orientation of the three-dimensional model G5 along with the movement of the cursor G43. The cursor G43 is moved to an arbitrary time by a drag-and-drop operation or the like. At this time, the display device draws the three-dimensional model G5 indicating the orientation of the work machine 100 at the time indicated by the cursor G43 after the movement.

Upon receiving a change in the value in the work machine selection form G1 from the user, the display device transmits a request message indicating the selected work machine ID to the work analysis device 300. Accordingly, the work analysis device 300 executes the processing of FIG. 5.

### Actions and Effects

As described above, according to the first embodiment, the display control system 1 includes the output unit 315 that outputs the remaining level of the battery 121 in the target time period and a work content of the work machine 100 in the target time period. This enables the user to recognize the relationship between the work content and power consumption.

Specifically, the display control system 1 according to the first embodiment receives selection of a target time period from among a plurality of time periods, and outputs a work content in the selected target time period. This enables the user to recognize the relationship between the work content and power consumption in any time period.

The display control system 1 according to the first embodiment displays the remaining level of the battery 121 for each time period as illustrated in FIG. 6, and receives designation of an arbitrary time period. This enables the user to confirm what kind of work has been performed in a time period in which the power consumption is rapidly reduced. In another embodiment, the display control system 1 may display the power consumption of the battery 121 per unit time or a power consumption amount in the time period in addition to or instead of the remaining level of the battery 121. The power consumption per unit time may be displayed for each unit work section. The power consumption and the power consumption amount may be displayed by, for example, a line graph. In another embodiment, the display control system 1 may display the total power consumption of the battery 121 in a target period in addition to or instead of the remaining level of the battery 121. The display control system 1 may display the power consumption for each unit work section. The display control system 1 can calculate the power consumption for each unit work section by adding up the power consumption in time periods in which a unit work section is performed for each unit work section.

### Other Embodiments

An embodiment has been described above in detail with reference to the drawings, but a specific configuration is not limited to that described above, and various design changes and the like can be made. That is, in other embodiments, the order of the processing described above may be changed as appropriate. Further, some processing may be executed in parallel. For example, the determination of the target work machine indicated from step S5 to step S8 and the determination of the target period indicated from step S9 to step S11 may be performed in a different order or may be performed at the same time.

The work analysis device 300 according to the above-described embodiment may be constituted by a single computer, or the configuration of the work analysis device 300 may be divided into a plurality of computers, and the plurality of computers may cooperate with each other to function as the work analysis device 300. In that case, some of the computers constituting the work analysis device 300 may be mounted inside the work machine 100 (for example, implemented by the control device 160), and other computers may be provided outside the work machine.

The work analysis device 300 according to the above-described embodiment is a web server, and the display screen is displayed by the display device accessing the work analysis device 300. On the other hand, in another embodiment, the work analysis device 300 may be mounted on the control device 160 or the operation terminal 142 of the work machine 100, and the work analysis device 300 may perform analysis and display control offline.

### REFERENCE SIGNS LIST

1 Display control system; 100 Work machine; 110 Traveling body; 111 Endless track; 112 Travel motor; 120 Revolving body; 121 Battery; 122 Hydraulic pump; 123 Control valve; 124 Revolution motor; 130 Work implement; 131 Boom; 131C Boom cylinder; 132 Arm; 132C Arm cylinder; 133 Bucket; 133C Bucket cylinder; 140 Cab; 141 Operator seat; 142 Operation terminal; 143 Operation device; 143LF left foot pedal; 143LO Left operation lever; 143LT Left travel lever; 143RF Right foot pedal; 143RO Right operation lever; 143RT Right travel lever; 143TB Turning brake pedal; 160 Control device; 300 Work analysis device; 31 Processor; 311 Data acquisition unit; 312 Input unit; 313 Authentication unit; 314 Estimation unit; 315 Output unit; 33 Main memory; 35 Storage; 351 Prediction model; 352 State table; 353 Account table; 37 Interface; G1 Work machine selection form; G2 Remaining battery level graph; G3 Unit work graph; G4 Work section map; G5 Three-dimensional model; T Loading target.

1. A display control system for a work machine driven by a battery,
the display control system comprising
an output unit configured to output a value related to power consumption in a target time period and a work content of the work machine in the target time period.

2. The display control system according to claim 1, comprising
an input unit configured to receive selection of a target time period from among a plurality of time periods, wherein
the work content in the selected target period is output.

3. The display control system according to claim 2, wherein
the output unit outputs a value related to power consumption in each of the plurality of time periods.

4. The display control system according to claim 1, wherein
the output unit outputs, as the work content, a graph indicating a breakdown of sections of unit work performed by the work machine in the target time period.

5. The display control system according to claim 4, wherein
the sections of the unit work include at least one of traveling, stopping, and charging.

6. The display control system according to claim 4, wherein
the work machine is an excavator, and
the sections of the unit work include dump loading.

7. The display control system according to claim 1, wherein the output unit outputs, as the work content, a graph indicating a temporal change in sections of unit work and element work which are performed by the work machine in the target time period.

8. The display control system according to claim 1, wherein the output unit outputs, as the work content, animation indicating a change in orientation of the work machine in the target time period.

9. The display control system according to claim 1, further comprising a display device configured to display information output by the output unit.

10. The display control system according to claim 2, wherein
the output unit outputs, as the work content, a graph indicating a breakdown of sections of unit work performed by the work machine in the target time period.

11. The display control system according to claim 3, wherein
the output unit outputs, as the work content, a graph indicating a breakdown of sections of unit work performed by the work machine in the target time period.

12. The display control system according to claim 10, wherein
the sections of the unit work include at least one of traveling, stopping, and charging.

13. The display control system according to claim 11, wherein
the sections of the unit work include at least one of traveling, stopping, and charging.

14. The display control system according to claim 10, wherein
the work machine is an excavator, and
the sections of the unit work include dump loading.

15. The display control system according to claim 11, wherein
the work machine is an excavator, and
the sections of the unit work include dump loading.

16. The display control system according to claim 2, wherein the output unit outputs, as the work content, a graph indicating a temporal change in sections of unit work and element work which are performed by the work machine in the target time period.

17. The display control system according to claim 3, wherein the output unit outputs, as the work content, a graph indicating a temporal change in sections of unit work and element work which are performed by the work machine in the target time period.

18. The display control system according to claim 2, wherein the output unit outputs, as the work content, animation indicating a change in orientation of the work machine in the target time period.

19. The display control system according to claim 3, wherein the output unit outputs, as the work content, animation indicating a change in orientation of the work machine in the target time period.

20. The display control system according to claim 2, further comprising a display device configured to display information output by the output unit.
